(19) United States
(12) Patent Application Publication
(10) Pub. No.: US 2023/0222325 A1
(43) Pub. Date: Jul. 13, 2023

(54) BINARY NEURAL NETWORK MODEL TRAINING METHOD AND SYSTEM, AND IMAGE PROCESSING METHOD AND SYSTEM

(71) Applicant: HEFEI UNIVERSITY OF TECHNOLOGY, Hefei (CN)

(72) Inventors: Yang WANG, Hefei (CN); Biao QIAN, Hefei (CN); Haipeng LIU, Hefei (CN); Meng WANG, Hefei (CN)

(73) Assignee: HEFEI UNIVERSITY OF TECHNOLOGY, Hefei (CN)

(21) Appl. No.: 18/080,777

(22) Filed: Dec. 14, 2022

(30) Foreign Application Priority Data
Jan. 12, 2022 (CN) 202210033086.2

(51) Int. Cl. G06N 3/045; G06N 3/048

(52) U.S. Cl. CPC G06N 3/045; G06N 3/048

(57) ABSTRACT

A binary neural network model training method and system includes constructing an online distillation-enhanced binary neural network training framework, wherein a teacher network in the online distillation-enhanced binary neural network training framework is an initial real-valued neural network model and an initial assistant neural network model, and a student network is an initial binary neural network model; and training the three network models using an online distillation method to improve the performance of a binary neural network. In addition, the binary neural network model is used for performing image classification on an image to be processed to improve the accuracy of the image classification.

### CROSS REFERENCE OF THE RELATED APPLICATION

This application claims priority of Chinese application No. 202210033086.2, filed on Jan. 12, 2022, the entire content of which is incorporated herein by reference.

### TECHNICAL FIELD

The present invention relates to the technical field of artificial intelligence, and in particular to a binary neural network model training method and system, and an image processing method and system.

### BACKGROUND

Deep neural networks have had a great success in computer vision tasks such as image classification and target detection. However, deep neural network models typically have millions of parameters and thus consume a lot of memories and a large number of computing resources to solve complex computational problems. In practice, there will be many challenges to deploy deep neural networks on embedded platforms and mobile devices because of the limitations of the computing resources. To solve this limitation, many methods reduce memory usage and computation overheads by compressing a network structure.

In the prior art, a binary neural network compresses a deep neural network by converting a floating point input and a network weight into a binary form. In order to reduce a performance difference between the binary neural network and a real-valued neural network, some classical network structures are proposed, such as, XNOR-Net which uses corresponding binarization parameters and scaling factors to reconstruct full-precision weights and activation values, so as to improve the performance of the binary neural network; and ABC-Net which uses a linear combination of multiple binary bases to approximate full-precision weights and activation values.

However, the above-mentioned binary neural network still has the following limitations:

(1) Since an extreme binarization bitwise operation may possibly cause a huge difference between information streams of the real-valued neural network and the binary neural network, quantization errors and gradient mismatches generated during forward propagation and backward propagation generally cause a huge performance difference between the real-valued neural network and the binary neural network. As a result, the class prediction accuracy of a specific computer vision task, such as an image classification task, of a binary neural network model is greatly reduced compared with that of the real-valued neural network, thereby limiting the deployment of the computer vision tasks such as image classification on a resource-limited platform (such as an embedded device).
(2) According to limitation (1), the huge performance difference may cause a loss in the accuracy of the real-valued neural network, which may affect the training of the binary neural network by the real-valued neural network. There is no method in the prior art to reduce the performance difference between the networks.
(3) For knowledge distillation, a student network is usually trained by a pre-trained teacher network in an off-line manner, so that the teacher network cannot obtain feedbacks of the student network. In other words, knowledge is transmitted from the teacher network to the student network in one direction. This will bring more obstacles to the knowledge distillation of the binary neural network.

In summary, how to provide a binary neural network model training method and system, and an image processing method and system is a problem urgently needing to be solved by those skilled in the art.

### SUMMARY

In view of this, the present invention provides a binary neural network model training method and system, and an image processing method and system. An online distillation technology is used to jointly train a binary neural network and a real-valued neural network, so that mutual communication of knowledge between networks is improved, and meanwhile, the real-valued neural network can better guide training of the binary neural network according to a feedback of the binary neural network. In addition, an assistant neural network provided by the present invention bridges knowledge migration between the real-valued neural network and the binary neural network to further improve the performance, and an online distillation-based binary neural network training framework is extended into a structure integrating three networks, so that the performance difference between a teacher network and a student network is further reduced, the performance of the binary neural network is improved, and the accuracy of image classification is improved.

In order to achieve the above objective, the present invention provides the following technical schemes.

In one aspect, the present invention provides a binary neural network model training method, which includes:

S100, constructing an online distillation-enhanced binary neural network training framework, wherein a teacher network in the online distillation-enhanced binary neural network training framework is an initial real-valued neural network model Θ_{R} and an initial assistant neural network model Θ_{A}, and a student network is an initial binary neural network model Θ_{B};

S200, training the initial real-valued neural network model Θ_{R}, the initial assistant neural network model Θ_{A} and the initial binary neural network model Θ_{B} for j times using an online distillation method to obtain a real-valued neural network model Θ_{R}^{j}, an assistant neural network model Θ_{A}^{j} and a binary neural network model Θ_{B}^{j};

S300, acquiring an image to be trained, and inputting the image to be trained into the real-valued neural network model Θ_{R}^{j} the assistant neural network model Θ_{A}^{j} and the binary neural network model Θ_{B}^{j} to obtain a category predicted value and an image category label of the image;

S400, performing calculation to obtain a target loss function value on the basis of the category predicted value and the image category label of the image, and updating parameters according to the target loss function value to obtain an updated real-valued neural network Θ_{R}^{j+1} assistant neural network Θ_{A}^{j+1} and binary neural network Θ_{B}^{j+1}; and

S500, taking the binary neural network Θ_{B}^{j+1} as a target binary neural network model when a preset training condition is satisfied.

Preferably, S100 includes constructing the initial binary neural network model Θ_{B};

acquiring the initial real-valued neural network model Θ_{R}, and binarizing the initial real-valued neural network model Θ_{R} to obtain an activation value Â_{b} and a weight Ŵ_{b} of a binary neural network:

Â_{b}=sign(A_{b})

Ŵ_{b}=sign(W_{b}).

where sign(.) is a sign function; A_{b} is an activation value; and W_{b} is a real-valued weight; and

constructing the initial binary neural network model Θ_{B} according to the activation value Â_{b} and the weight Ŵ_{b}.

Preferably, S100 further includes constructing the initial assistant neural network model Θ_{A};

obtaining a soft activation value Ã_{S} of the initial assistant neural network Θ_{A}:

$$Forward : \tilde{{A}_{s}} = Soft ( {A}_{s} ) ; \\ Backward : \frac{\partial L {Θ}_{A}}{\partial {A}_{s}} = \frac{\partial L {Θ}_{A}}{{\tilde{\partial A}}_{s}} \frac{\partial Soft ( {A}_{s} )}{\partial {A}_{s}} ;$$

where Â_{S} is the soft activation value; L_{Θ}_{_{A}} is a loss function of the assistant neural network; Soft(⋅) is a piecewise function; A_{S} is a full-precision activation value;

obtaining a soft weight \tilde{W}_{S} of the initial assistant neural network Θ_{A}:

$$Forward : \tilde{{W}_{s}} = Soft ( {W}_{s} ) ; \\ Backward : \frac{\partial L {Θ}_{A}}{\partial {A}_{s}} = \frac{\partial L {Θ}_{A}}{{\tilde{\partial W}}_{s}} \frac{\partial Soft ( {W}_{s} )}{\partial {W}_{s}} ;$$

where \tilde{W}_{S} is a soft weight value; L_{Θ}_{_{A}} is the loss function of the assistant neural network; Soft(⋅) is the piecewise function; and W_{S} is a real-valued weight; and

constructing the initial assistant neural network model Θ_{A} according to the soft activation value Ã_{S} and the soft weight \tilde{W}_{S}.

Preferably, S400 includes:

S410, performing calculation to obtain a target loss function value on the basis of a category predicted value and an image category label of an image:

L_{ΘB}=L_{ce}(y,P_{B})+Lₘ(Θ_{B});

L_{ΘA}=L_{ce}(y,P_{A})+Lₘ(Θ_{A});

L_{ΘR}=L_{ce}(y,P_{R})+Lₘ(Θ_{R});

where y is the image category label; P_{B} is a category predicted value of the initial binary neural network model Θ_{B} for an input picture; P_{A} is a category predicted value of the initial assistant neural network model Θ_{A} for the input picture; P_{R} is a category predicted value of the initial real-valued neural network model Θ_{R} for the input picture; L_{Θ}_{_{B}} is an overall loss function of the initial binary neural network model Θ_{B}; L_{Θ}_{_{A}} is an overall loss function of the initial assistant neural network model Θ_{A}; L_{Θ}_{_{R}} is an overall loss function of the initial real-valued neural network model Θ_{R}; and

S420, performing training for j+1 times according to the target loss function value, and updating parameters to obtain an updated real-valued neural network model Θ_{R}^{j+1} assistant neural network model Θ_{A}^{j+1} and Θ_{B}^{j+1} binary neural network model.

Preferably, the target loss function value includes the simulated loss item Lₘ(⋅); the simulated loss item Lₘ(⋅) is composed of two simulated loss sub-items Lₘ(.,.); calculation formulas are as follows:

Lₘ(Θ_{B})=α_{RB}Lₘ(P_{R},P_{B})+β_{AB}Lₘ(P_{A},P_{B});

Lₘ(Θ_{A})=α_{RA}Lₘ(P_{R},P_{A})+β_{BA}Lₘ(P_{B},P_{A});

Lₘ(Θ_{R})=α_{AR}Lₘ(P_{A},P_{R})+β_{BR}Lₘ(P_{B},P_{R});

where P_{A} is the category predicted value of the initial assistant neural network model Θ_{A} for the input picture; P_{R} is the category predicted value of the initial real-valued neural network model Θ_{R} for the input picture; P_{B} is the category predicted value of the initial binary neural network model Θ_{B} for the input picture; α_{RB}, α_{RA}, α_{AB}, β_{AB}, β_{BA} and β_{BR} are simulation factors;

a calculation formula of the simulated loss sub-item Lₘ(.,.) is as follows:

$${L}_{m} ( {P}_{X} , {P}_{Y} ) = {\sum }_{i = 1}^{N} {\sum }_{j = 1}^{M} {P}_{X}^{j} ( {x}_{i} ) log \frac{{P}_{X}^{j} ( {x}_{i} )}{{P}_{Y}^{j} ( {x}_{i} )}$$

where P_{X}^{j}(xᵢ) refers to a category predicted value of an i^{th} sample among training samples input into a network Θ_{X}; P_{Y}^{j}(xᵢ) refers to a category predicted value of an i^{th} sample among training samples input into the binary numerical network Θ_{Y}; N is a size of each training sample; and M is the number of categories of samples in a dataset.

Preferably, the target loss function value further includes the cross-entropy loss item L_{ce}(⋅,⋅), and a calculation formula is as follows:

$${L}_{ce} ( y , P ) = {\sum }_{i}^{N} y log ( {P}_{i} )$$

where y is an image category label; pᵢ is the category predicted value of the i^{th} sample among the training samples input into the network; and N is the size of each training sample.

Preferably, S500 includes: training the real-valued neural network model, the assistant neural network model and the initial binary neural network model jointly for K times, wherein for the (j+1)^{th} training, 1≤j+1≤K, where j is a positive integer; and when j+1=K, taking the binary neural network Θ_{B}^{j+1} as the target binary neural network, otherwise, enabling j=j+1, and returning to step S200 for repeated training.

In another aspect, the present invention provides a binary neural network model training system, which includes:

a construction module, configured for constructing an online distillation-enhanced binary neural network training framework, wherein a teacher network in the online distillation-enhanced binary neural network training framework is an initial real-valued neural network model Θ_{R} and an initial assistant neural network model Θ_{A}, and a student network is an initial binary neural network model Θ_{B};

a training module, connected with the construction module and configured for training the initial real-valued neural network model Θ_{R}, the initial assistant neural network model Θ_{A} and the initial binary neural network model Θ_{B} for j times using an online distillation method to obtain a real-valued neural network model Θ_{R}^{j}, an assistant neural network model Θ_{A}^{j} and a binary neural network model Θ_{B}^{j};

a processing module, connected with the training module and configured for acquiring a dataset to be trained, and inputting the dataset to be trained into the real-valued neural network model Θ_{B}^{j}, the assistant neural network model Θ_{A}^{j} and the binary neural network model Θ_{B}^{j} to obtain a category predicted value and a dataset category label of a picture in the dataset;

an updating module, connected with the processing module and configured for performing calculation to obtain a target loss function value on the basis of the category predicted value and dataset category label of the picture in the dataset, and updating parameters according to the target loss function value to obtain an updated real-valued neural network Θ_{R}^{j+1}, assistant neural network Θ_{A}^{j+1} and binary neural network Θ_{B}^{j+1}; and

a determining module, connected with the updating module and configured for taking the binary neural network Θ_{B}^{j+1} as a target binary neural network model when a preset training condition is satisfied.

In another aspect, the present invention provides an image processing method, to which the above obtained target binary neural network model is applied. The image processing method includes:

S10, acquiring an image to be processed;

S20, performing image classification processing on the image to be processed using the target binary neural network model; and

S30, obtaining and outputting a classification processing result.

In still another aspect, the present invention provides an image processing system, which includes:

an acquisition module, configured for acquiring an image to be processed;

a classification processing module, connected with the acquisition module and configured for performing image classification processing on the image to be processed using a target binary neural network model; and

an output module, connected with the classification processing module and configured for acquiring the image to be processed, performing image classification processing on the image to be processed using the target binary neural network model, and obtaining and outputting a classification processing result.

According to the technical schemes, compared with the prior art, the present invention provides a binary neural network model training method and system, and an image processing method and system. The constructed online distillation-enhanced binary neural network training framework achieves interaction of knowledge between the teacher network and the student network. The assistant neural network helps to establish connection between the real-valued neural network and the binary neural network, and the online distillation-based binary neural network training framework is extended into an integrated structure of three networks. The performance difference between the teacher network and the student network is reduced, which further improves the performance of the networks, so that the accuracy of image classification is improved.

### BRIEF DESCRIPTION OF THE DRAWINGS

In order to more clearly illustrate the technical schemes in the examples of the present invention or in the prior art, the drawings required to be used in the description of the examples or the prior art are briefly introduced below. It is obvious that the drawings in the description below are merely examples of the present invention, and those of ordinary skilled in the art can obtain other drawings according to the drawings provided without creative efforts.

FIG. 1 is a flow chart of a binary neural network model training method provided in the present invention;

FIG. 2 is a schematic structural diagram of an online distillation-enhanced binary neural network training framework provided in Example 1; and

FIG. 3 is a schematic structural diagram of a binary neural network model training system provided in Example 1.

### DETAILED DESCRIPTION OF THE EMBODIMENTS

The technical schemes in the embodiments of the present invention will be clearly and completely described below with reference to the drawings in the embodiments of the present invention, and it is obvious that the described embodiments are only a part of the embodiments of the present invention but not all of them. Based on the embodiments of the present invention, all other embodiments obtained by those of ordinary skilled in the art without creative efforts shall fall within the protection scope of the present invention.

### Example 1

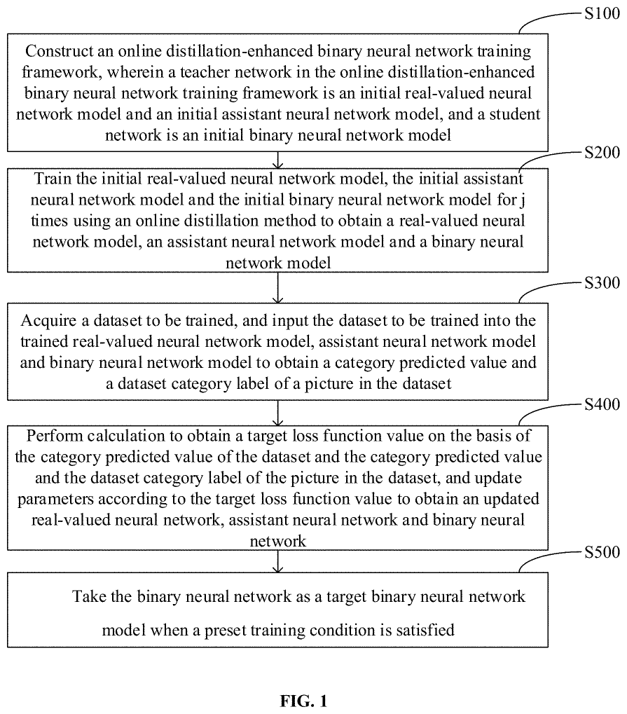

In one aspect, referring to FIG. 1, Example 1 of the present invention discloses a binary neural network model training method, which includes:

S100, constructing an online distillation-enhanced binary neural network training framework, wherein a teacher network in the online distillation-enhanced binary neural network training framework is an initial real-valued neural network model Θ_{R} and an initial assistant neural network model Θ_{A} and a student network is an initial binary neural network model Θ_{B};

S200, training the real-valued neural network model Θ_{R}, the initial assistant neural network model Θ_{A} and the initial binary neural network model Θ_{B} for j times using an online distillation method to obtain a real-valued neural network model Θ_{R}^{j}, an assistant neural network model Θ_{A}^{j} and a binary neural network model Θ_{B}^{j};

S300, acquiring a dataset to be trained, and inputting the dataset to be trained into the trained real-valued neural network model Θ_{R}^{j}; assistant neural network model Θ_{A}^{j} and binary neural network model Θ_{B}^{j} to obtain a category predicted value and a dataset category label of a picture in the dataset;

S400, performing calculation to obtain a target loss function value on the basis of the category predicted value and the dataset category label of the picture in the dataset, and updating parameters according to the target loss function value to obtain an updated real-valued neural network Θ_{R}^{j+1}, assistant neural network Θ_{A}^{j+1} and binary neural network Θ_{B}^{j+1}; and

S500, taking the binary neural network Θ_{B}^{j+1} as a target binary neural network model when a preset training condition is satisfied.

Specifically, when the target binary neural network model is applied to image processing, the dataset to be trained is an image dataset to be trained.

In one specific embodiment, the binary neural network is an efficient neural network compression method that compresses a network structure by binarizing floating point inputs and full-precision network weights. After the real-valued neural network is compressed by binarization, weights and activations in the network can be represented by 1-digit numerical values (such as +1 or −1), without occupying too many memories.

For a full-precision real-valued neural network, A_{b} is a full-precision activation value (input value), and W_{b} is a real-valued weight. The real-valued neural network is binarized through the following calculation to obtain an activation value Â_{b} and a weight Ŵ_{b} of the binary neural network:

Â_{b}=sign(A_{b})

Ŵ_{b}=sign(W_{b}) (1)

In formula (1), sign(.) is a sign function. If a function input is positive, and an output is 1, a negative value is −1, a derivative of the function is a pulse function. Meanwhile, a gradient of the sign function is estimated in a back propagation process by using a straight-forward method, and a weight average value is used to estimate a gradient of the activation function.

Through the above technical schemes, the initial binary neural network model Θ_{B} corresponding to the initial real-valued neural network model Θ_{R} is obtained.

However, the activation value and weight of the real-valued neural network are directly binarized, so that a quantization error and gradient mismatch will be generated during forward propagation of parameters and backward propagation of gradients. As a result, the performance of the binary neural network is sharply reduced compared with that of the full-precision real-valued neural network.

In one specific embodiment, in order to solve the problem of a sharp decline in the performance of the binary neural network, the present invention provides an online distillation-enhanced binary neural network, i.e., ODE-BNN. Parameters of the compressed binary neural network are trained through the ODE-BNN. Through online distillation, the full-precision real-valued neural network with better performance is used to guide the training of the binary neural network, so that the performance of the binary neural network can be greatly improved. However, this improvement is limited by the performance difference between the real-valued neural network and the binary neural network due to the quantization error and the gradient mismatch which are generated in the forward and backward propagations. Therefore, only the real-valued neural network is used to perform the online distillation on the binary neural network, and a good enough guidance cannot be provided for the binary neural network. Furthermore, the present invention further provides constructing a soft assistant neural network to solve the above problem. The assistant neural network is like a bridge for connecting the real-valued neural network to the binary neural network. A soft method can smooth the quantization step and avoid the gradient mismatch. In an aspect, the precision of the assistant neural network is between that of the real-valued neural network and that of the binary neural network, which is beneficial to realizing information exchange between the real-valued neural network and the binary neural network and helps to improve the performance of the binary neural network. In another aspect, the assistant neural network can provide the guidance for the training of the binary neural network in conjunction with the real-valued neural network.

In one specific embodiment, a soft assistant neural network corresponding to the real-valued neural network is constructed by using a soft method, that is, a soft activation value Âₛ and a soft weight \tilde{W}_{S} of the initial assistant neural network model Θ_{A} are obtained by using the soft method, thus constructing the initial assistant neural network model Θ_{A}.

For the full-precision activation value Aₛ of the network Θ_{A}, in order to obtain the soft activation value Âₛ of the network, forward and backward propagation formulas are as follows:

$$forward propagation : \tilde{{A}_{s}} = Soft ( {A}_{S} ) \\ backward propagation : \frac{\partial {{L}_{Θ}}_{A}}{\partial {A}_{S}} = \frac{\partial {L}_{{Θ}_{A}}}{\partial \tilde{{A}_{S}}} \frac{\partial Soft ( {A}_{S} )}{\partial {A}_{S}} \qquad ( 2 )$$

where L_{Θ}_{_{A}} is a loss function of the assistant neural network, and Soft(⋅) is a piecewise function as follows:

$$Soft ( a ) = \{ \begin{matrix}- 1 & if a < - 1 \\ 2 a + {a}^{2} & if - 1 \leq a < 0 \\ 2 a - {a}^{2} & if 0 \leq a < 1 \\ 1 & otherwise\end{matrix} \qquad ( 3 )$$

$$\frac{\partial Soft ( a )}{\partial a} = \{ \begin{matrix}2 + 2 a & if - 1 \leq a < 0 \\ 2 - 2 a & if 0 \leq a < 1 \\ 0 & otherwise\end{matrix} \qquad ( 4 )$$

Similarly, for a real-valued weight W_{S} of the assistant neural network, the soft weight \tilde{W}_{S} of the network can be obtained through calculation by the following forward propagation and backward propagation:

$$Forward : {W}_{s} = Soft ( {W}_{S} ) \\ Backward : \frac{\partial {{L}_{Θ}}_{A}}{\partial {W}_{S}} = \frac{\partial {L}_{{Θ}_{A}}}{\partial {W}_{S}} \frac{\partial Soft ( {W}_{S} )}{\partial {W}_{S}} \qquad ( 5 )$$

where L_{Θ}_{_{A}} is the loss function of the assistant neural network.

The soft activation value Ã_{S} and the soft weight \tilde{W}_{S} of the initial assistant neural network model Θ_{A} can be obtained through formula (2) and formula (5) described above.

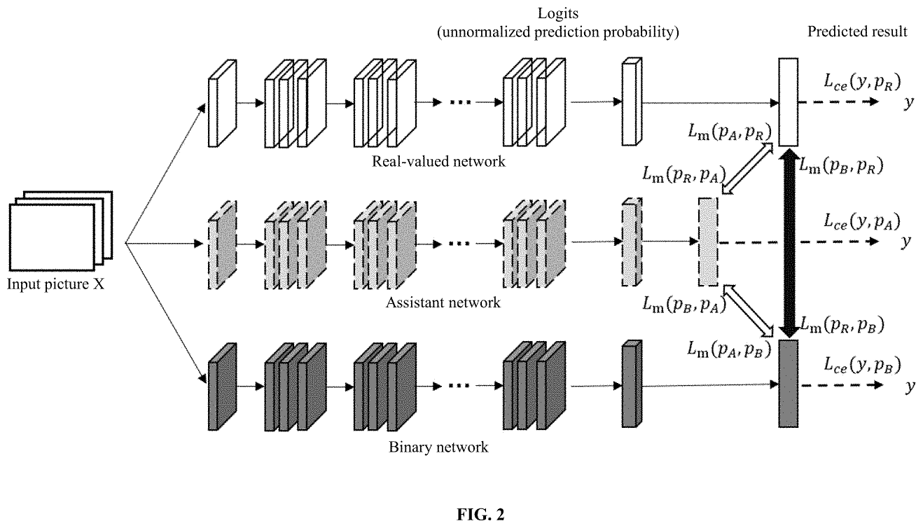

Referring to FIG. 2, an embodiment of the present invention provides a schematic structural diagram of an online distillation-enhanced binary neural network training framework. In one specific embodiment, the initial real-valued neural network Θ_{R}, the initial binary neural network θ_{B} and the initial assistant neural network Θ_{A} are integrated into the online distillation-enhanced binary neural network training framework. A parameter optimization process for the binary neural network is guided using the real-valued neural network and the assistant neural network by means of online distillation. A teacher network in the online distillation framework is the initial real-valued neural network Θ_{R} and the initial assistant neural network Θ_{A}, and a student network is the initial binary neural network Θ_{B}.

For an image classification task, the binary neural network is trained for K times on the basis of the online distillation framework. For the (j+1)^{th} training (1≤j+1≤K), a training image is input into each neural network under the online distillation framework, i.e., the real-valued neural network Θ_{R}^{j}, the binary neural network Θ_{B}^{j} and the assistant neural network Θ_{A}^{j} where Θ_{R}^{j}, Θ_{B}^{j} and Θ_{A}^{j} are obtained on the basis of the j^{th} training. Each neural network respectively processes the picture to obtain a category predicted value of the network for the input picture for this training.

Then, a loss function value of this training process is obtained through calculation through the following target function formula (6) on the basis of the category predicted value and the image category label of the image described above, and the parameters of each neural network model are updated on the basis of the target loss function value. The loss function is composed of a simulated loss item Lₘ(⋅) and a cross-entropy loss item L_{ce}(⋅,⋅). The simulated loss item is used for describing differences between the category predicted value of the image, input for the (j+1)^{th} training, of any one neural network (such as the binary neural network Θ_{B}) in the framework and the category predicted values of the image of the other two neural networks (such as the real-valued neural network Θ_{R} and the assistant neural network Θ_{A}) in the framework. The cross-entropy loss item is used for describing a difference between the output category predicted value of the image, input for the (j+1)^{th} training, of any network in the framework and a real category label of the image.

L_{ΘB}=L_{ce}(y,P_{B})+Lₘ(Θ_{B})

L_{ΘA}=L_{ce}(y,P_{A})+Lₘ(Θ_{A})

L_{ΘR}=L_{ce}(y,P_{R})+Lₘ(Θ_{R}) (6)

Where y is an image category label; P_{B} is a category predicted value of the binary neural network Θ_{B}; P_{A} is a category predicted value of the assistant neural network Θ_{A}; P_{R} is a category predicted value of the real-valued neural network Θ_{R}; L_{Θ}_{_{B}} is an overall loss function of the binary neural network Θ_{B}; L_{Θ}_{_{A}} is an overall loss function of the assistant neural network Θ_{A}; L_{Θ}_{_{R}} is an overall loss function of the real-valued neural network Θ_{R}.

Through the above (j+1)^{th} training, the three neural networks in the training framework are synchronously trained, and parameters are updated, so that the real-valued neural network Θ_{R}^{j+1} the binary neural network Θ_{B}^{j+1} and the assistant neural network Θ_{A}^{j+1} are obtained. At this time, if a preset condition is satisfied (if j+1=K, that is, the current number of trainings is a preset number of trainings), the binary neural network Θ_{B}^{j+1} obtained by the training in the framework as described above can be taken as a target binary neural network. Otherwise, j=j+1 is set, and the training is continued.

In one specific embodiment, a specific calculation process for the simulated loss item Lₘ(⋅) and the cross-entropy loss item L_{ce}(⋅,⋅) is as follows:

(1) The simulated loss item Lₘ(⋅) is composed of two simulated loss sub-items Lₘ(.,.). Each simulated loss sub-item describes a difference between the output category predicted values of any two networks in the online distillation framework, so that one network can learn the output of another network as much as possible by minimization Lₘ(.,.). For example, the simulated loss item Lₘ (Θ_{B}) of the binary neural network is composed of a simulated loss sub-item Lₘ(P_{R},P_{B}) between the binary neural network and the real-valued neural network and a simulated loss sub-item Lₘ(P_{A},P_{B}) between the binary neural network and the assistant neural network. The binary neural network learns from the teacher network (namely the real-valued neural network and the assistant neural network) through the simulated loss item, so that the target binary neural network obtained through the training is closer to the teacher network in terms of a picture category prediction result, and the prediction accuracy of the binary neural network is further improved. The following formula is the simulated loss item Lₘ(⋅) corresponding to each network in the framework:

Lₘ(Θ_{B})=α_{RB}Lₘ(P_{R},P_{B})+β_{AB}Lₘ(P_{A},P_{B})

Lₘ(Θ_{A})=α_{RA}Lₘ(P_{R},P_{A})+β_{BA}Lₘ(P_{B},P_{A})

Lₘ(Θ_{R})=α_{AR}Lₘ(P_{A},P_{R})+β_{BR}Lₘ(P_{B},P_{R}) (7)

where P_{A} is the category predicted value of the input picture by the assistant neural network Θ_{A}; P_{R} is the category predicted value of the input picture by the real-valued neural network Θ_{R}; P_{B} is the category predicted value of the input picture by the binary neural network Θ_{B}; α** and β** are simulation factors for balancing the two simulated losses. In an implementation, α_{RB} is set to be 0.5; β_{AB} is set to be 0.5; α_{RA} is set to be 0.7; β_{BA}, α_{AR} and β_{BR} are set to be 1. Meanwhile, a specific calculation formula of the simulated loss sub-item Lₘ(.,.) is as follows:

$${L}_{m} ( {P}_{X} , {P}_{Y} ) = {\sum }_{i = 1}^{N} {\sum }_{j = 1}^{M} {P}_{X}^{j} ( {x}_{i} ) log \frac{{P}_{X}^{j} ( {x}_{i} )}{{P}_{Y}^{j} ( {x}_{i} )} \qquad ( 8 )$$

where P_{X}^{j}(xᵢ) refers to a category predicted value of an i^{th} sample among training samples input into a network Θ_{X}; P_{Y}^{j}(xᵢ) refers to a category predicted value of an i^{th} sample among training samples input into the binary numerical network Θ_{Y}. N is the size of this batch of training samples, and M is the number of categories of samples in the dataset.

From the simulated loss item, the binary neural network learns the distribution of the output category predicted value of the real-valued neural network through the simulated loss item, and the real-valued neural network also receives a feedback of the binary neural network through the simulated loss at the same time and provides a better guidance for the whole training process. Meanwhile, the binary neural network learns the distribution of the output category predicted value of the assistant neural network through the simulated loss item. The performance of the assistant neural network is between that of the real-valued neural network and that of the binary neural network, so that the huge difference between the real-valued neural network and the binary neural network can be made up, which is beneficial to realizing information exchange between the real-valued neural network and the binary neural network and helps to improve the performance of the binary neural network.

(2) The cross-entropy loss L_{ce}(⋅) can be obtained by the following formula. The loss item enables the networks to learn a correct distribution of data by means of comparing the category predicted values of the neural networks in the framework with the image labels, so that the model prediction accuracy is improved,

$${L}_{ce} ( y , p ) = {{\sum }_{i}}^{N} y log ( {p}_{i} ) \qquad ( 9 )$$

where y is an image category label; pᵢ is the category predicted value of the i^{th} sample among the training samples input into the network; and N is the size of this batch of samples.

Through the above technical schemes, the online distillation network framework is used in the present invention, and the performance of the binary neural network is greatly improved by means of jointly training the real-valued neural network and the binary neural network. Meanwhile, the framework also constructs the soft assistant neural network, so that the quantization step is smoothed, and the gradient mismatches are reduced in the training process, which makes up the huge difference between the real-valued neural network and the binary neural network, thus further improving the performance of the binary neural network. Numerous experiments on multiple common datasets also validate the effectiveness of the method.

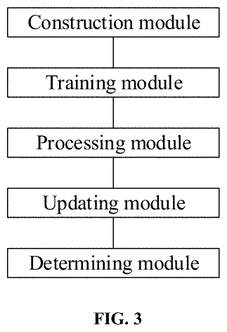

In another aspect, referring to FIG. 3, Example 1 of the present invention further provides a binary neural network model training system, which includes:

a construction module, configured for constructing an online distillation-enhanced binary neural network training framework, wherein a teacher network in the online distillation-enhanced binary neural network training framework is an initial real-valued neural network model Θ_{R} and an initial assistant neural network model Θ_{A}, and a student network is an initial binary neural network model Θ_{B};

a training module, connected with the construction module and configured for training the real-valued neural network model Θ_{R}, the initial assistant neural network model Θ_{A} and the initial binary neural network model Θ_{B} for j times using an online distillation method to obtain a real-valued neural network model Θ_{R}^{j}, an assistant neural network model Θ_{A}^{j} and a binary neural network model Θ_{B}^{j};

a processing module, connected with the training module and configured for acquiring a dataset to be trained, and inputting the dataset to be trained into the trained real-valued neural network model Θ_{B}^{j} assistant neural network model Θ_{A}^{j} and binary neural network model Θ_{B}^{j} to obtain a category predicted value and a dataset category label of a picture in the dataset;

an updating module, connected with the processing module and configured for performing calculation to obtain a target loss function value on the basis of the category predicted value and the dataset category label of the picture in the dataset, and updating parameters according to the target loss function value to obtain an updated real-valued neural network Θ_{R}^{j+1}, assistant neural network Θ_{A}^{j+1} and binary neural network Θ_{B}^{j+1}; and

a determining module, connected with the updating module and configured for taking the binary neural network Θ_{B}^{j+1} as a target binary neural network model when a preset training condition is satisfied.

In another aspect, Example 1 further provides an image processing method, to which the above obtained target binary neural network model is applied. The image processing method includes:

S10, acquiring an image to be processed;

S20, performing image classification processing on the image to be processed using the target binary neural network model; and

S30, obtaining and outputting a classification processing result.

In still another aspect, Example 1 further provides an image processing system, which includes:

an acquisition module, configured for acquiring an image to be processed;

a classification processing module, connected with the acquisition module and configured for performing image classification processing on the image to be processed using the target binary neural network model; and

an output module, connected with the classification processing module and configured for acquiring the image to be processed, performing image classification processing on the image to be processed using the target binary neural network model, and obtaining and outputting a classification processing result.

According to the technical schemes, compared with the prior art, the present invention provides a binary neural network model training method and system, and an image processing method and system. The constructed online distillation-enhanced binary neural network training framework achieves interaction of knowledge between the teacher network and the student network. The assistant neural network helps to establish connection between the real-valued neural network and the binary neural network, and the online distillation-based binary neural network training framework is extended into a structure integrating three networks. The performance difference between the teacher network and the student network is reduced, which further improves the performance of the networks, so that the accuracy of image classification is improved.

### Example 2

In order to verify the effectiveness of the above method, numerous experiments are carried out on three common reference datasets. Experimental results prove that the present invention has a significant improvement effect on the performance of the binary neural network, and can obtain the highest accuracy improvements of 3.15% and 6.67% respectively on CIFAR10 datasets and CIFAR100 datasets. Meanwhile, the experimental results also prove that the assistant neural network has a positive effect on reducing the difference between the teacher network and the student network, and the assistant neural network can help the ODE-BNN to respectively obtain the highest accuracy improvements of 0.87% and 3.48% respectively on CIFAR10 datasets and CIFAR 100 datasets.

The embodiments in the specification are all described in a progressive manner, and each embodiment focuses on differences from other embodiments, and portions that are the same and similar between the embodiments may be referred to each other. Since the device disclosed in the embodiment corresponds to the method disclosed in the embodiment, the description is relatively simple, and reference may be made to the partial description of the method.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to accord with the broadest scope consistent with the principles and novel features disclosed herein.

1. A binary neural network model training method, comprising the following steps:
S100, acquiring an image to be processed;
S200, constructing an online distillation-enhanced binary neural network training framework, wherein a teacher network in the online distillation-enhanced binary neural network training framework is an initial real-valued neural network model Θ_{R} and an initial assistant neural network model Θ_{A}, and a student network is an initial binary neural network model Θ_{B};
S300, training the initial real-valued neural network model Θ_{R}, the initial assistant neural network model Θ_{A}, and the initial binary neural network model Θ_{B} for j times using an online distillation method to obtain a real-valued neural network model Θ_{R}^{j} an assistant neural network model Θ_{A}^{j}, and a binary neural network model Θ_{B}^{j};
S400, acquiring a dataset to be trained, and inputting the dataset to be trained into the real-valued neural network model Θ_{R}^{j}, the assistant neural network model Θ_{A}^{j}, and the binary neural network model Θ_{B}^{j} to obtain a category predicted value and a dataset category label of a picture in the dataset;
S500, performing calculation to obtain a target loss function value on the basis of the category predicted value and the dataset category label of the picture in the dataset, and updating parameters according to the target loss function value to obtain an updated real-valued neural network Θ_{R}^{j+1}, assistant neural network Θ_{A}^{j+1}, and binary neural network Θ_{B}^{j+1};
S600, taking the binary neural network Θ_{B}^{j+1} as a target binary neural network model when a preset training condition is satisfied;
S700, performing an image classification processing on the image to be processed using the target binary neural network model; and
S800, obtaining and outputting a classification processing result;
wherein,
S500 comprises:
S510, performing calculation to obtain a target loss function value on the basis of a category predicted value and an image category label of an image:
L_{ΘB}=L_{ce}(y,P_{B})+Lₘ(Θ_{B});
L_{ΘA}=L_{ce}(y,P_{A})+Lₘ(Θ_{A});
L_{ΘR}=L_{ce}(y,P_{R})+Lₘ(Θ_{R});
where y is the image category label; P_{B} is a category predicted value of the initial binary neural network model Θ_{B} for an input picture; P_{A} is a category predicted value of the initial assistant neural network model Θ_{A} for the input picture; P_{R} is a category predicted value of the initial real-valued neural network model Θ_{R} for the L_{Θ}_{_{A}} input picture; L_{Θ}_{_{B}} is an overall loss function of the initial binary neural network model Θ_{B}; L_{Θ}_{_{A}} is an overall loss function of the initial assistant neural network model Θ_{A}; L_{Θ}_{_{R}} is an overall loss function of the initial real-valued neural network model Θ_{R}; Lₘ(⋅) is a simulated loss item; L_{ce}(⋅,⋅) is a cross entropy loss item;
S520, performing training for j+1 times according to the target loss function value, and updating parameters to obtain the updated real-valued neural network model Θ_{R}^{j+1}, assistant neural network model Θ_{A}^{j+1}, and binary neural network model Θ_{B}^{j+1}; wherein
the target loss function value comprises the simulated loss item Lₘ(⋅); the simulated loss item Lₘ(⋅) is composed of two simulated loss sub-items Lₘ(.,.); calculation formulas are as follows:
Lₘ(Θ_{B})=α_{RB}Lₘ(P_{R},P_{B})+β_{AB}Lₘ(P_{A},P_{B});
Lₘ(Θ_{A})=α_{RA}Lₘ(P_{R},P_{A})+β_{BA}Lₘ(P_{B},P_{A});
Lₘ(Θ_{R})=α_{AR}Lₘ(P_{A},P_{R})+β_{BR}Lₘ(P_{B},P_{R});
where P_{A} is the category predicted value of the initial assistant neural network model Θ_{A} for the input picture; P_{R} is the category predicted value of the initial real-valued neural network model Θ_{R} for the input picture; P_{B} is the category predicted value of the initial binary neural network model Θ_{B} for the input picture; α_{RB}, α_{RA}, α_{AB}, β_{AB}, β_{BA} and β_{BR} are simulation factors;
a calculation formula of the simulated loss sub-item Lₘ(.,.) is as follows:
$${L}_{m} ( {P}_{X} , {P}_{Y} ) = {\sum }_{i = 1}^{N} {P}_{X} ( {x}_{i} ) log \frac{{P}_{X} ( {x}_{i} )}{{P}_{Y} ( {x}_{i} )}$$
where P_{X}(xᵢ) refers to a category predicted value of an i^{th} sample among training samples input into a network Θ_{X}; P_{Y}(xᵢ) refers to a category predicted value of an i^{th} sample among training samples input into a binary numerical network Θ_{Y}; and N is a size of each training sample.

2. The binary neural network model training method according to claim 1, wherein S200 further comprises constructing the initial binary neural network model Θ_{B}:
acquiring the initial real-valued neural network model Θ_{R}, and binarizing the initial real-valued neural network model Θ_{R} to obtain an activation value Â_{b} and a weight Ŵ_{b} of a binary neural network:
Â_{b}=sign(A_{b});
Ŵ_{b}=sign(W_{b});
where sign(.) is a sign function; A_{b} is a full-precision activation value of the real-valued neural network model; W_{b} is a real-valued weight; and
constructing the initial binary neural network model Θ_{B} according to the activation value Â_{b} and the weight Ŵ_{b}.

3. The binary neural network model training method according to claim 1, wherein S200 further comprises constructing the initial assistant neural network model Θ_{A}:
obtaining a soft activation value Ã_{S} of the initial assistant neural network Θ_{A}:
$$Forward : {\tilde{A}}_{s} = Soft ( {A}_{s} ) ; \\ Backward : \frac{\partial L {Θ}_{A}}{\partial {A}_{s}} = \frac{\partial L {Θ}_{A}}{{\tilde{\partial A}}_{s}} \frac{\partial Soft ( {A}_{s} )}{\partial {A}_{s}} ;$$
where Ãₛ is the soft activation value; L_{Θ}_{_{A}} is a loss function of the assistant neural network; Soft(⋅) is a piecewise function; A_{S} is a full-precision activation value;
obtaining a soft weight \tilde{W}_{S} of the initial assistant neural network Θ_{A}:
$$Forward : \tilde{{W}_{s}} = Soft ( {W}_{s} ) ; \\ Backward : \frac{\partial L {Θ}_{A}}{\partial {A}_{s}} = \frac{\partial L {Θ}_{A}}{{\tilde{\partial W}}_{s}} \frac{\partial Soft ( {W}_{s} )}{\partial {W}_{s}} ;$$
where \tilde{W}_{S} is a soft weight value; L_{Θ}_{_{A}} is the loss function of the assistant neural network; Soft(⋅) is the piecewise function; W_{S} is a real-valued weight; and
constructing the initial assistant neural network model Θ_{A} according to the soft activation value Ã_{S} and the soft weight \tilde{W}_{S}.

4. The binary neural network model training method according to claim 1, wherein the target loss function value further comprises the cross-entropy loss item L_{ce}(⋅,⋅), and a calculation formula is as follows:
$${L}_{c e} ( y , P ) = {\sum }_{i}^{N} y log ( {P}_{i} )$$
where y is an image category label; pᵢ is the category predicted value of the i^{th} sample among the training samples input into the network; and N is the size of each training sample.

5. The binary neural network model training method according to claim 1, wherein S600 further comprises: training the real-valued neural network model, the assistant neural network model, and the initial binary neural network model jointly for K times, wherein for the (j+1)^{th} training, 1≤j+1≤K, where j is a positive integer; and when j+1=K, taking the binary neural network Θ_{B}^{j+1} as the target binary neural network, otherwise, enabling j=j+1, and returning to step S300 for repeated training.

6. An image processing system, comprising:
an acquisition module, configured for acquiring an image to be processed;
a classification processing module, connected with the acquisition module and configured for performing image classification processing on the image to be processed using a target binary neural network model; and
an output module, connected with the classification processing module and configured for acquiring the image to be processed, performing image classification processing on the image to be processed using the target binary neural network model, and obtaining and outputting a classification processing result.
